(19) United States
(12) Patent Application Publication
(10) Pub. No.: US 2018/0137437 A1
(43) Pub. Date: May 17, 2018

(54) PAYMENT SYSTEMS FOR MULTIPLE SHARED DRIVERS

(71) Applicant: Wai Ling Chan, Hong Kong (HK)

(72) Inventor: Wai Ling Chan, Hong Kong (HK)

(21) Appl. No.: 15/352,518

(22) Filed: Nov. 15, 2016

(51) Int. Cl. G06Q 10/02; G06Q 20/10; G06K 19/06

(52) U.S. Cl. CPC G06Q 10/02; G06Q 50/30; G06K 19/06037; G06Q 20/102

(57) ABSTRACT

According to embodiments of the invention, systems and methods are provided for a shared vehicle payment system for managing various charges made on behalf of multiple drivers of a given vehicle. The disclosed systems and methods may be carried out by assigning a console and account module to a given vehicle. The console may have an associated detachable mobile device and sensor device. The vehicle may communicate with a centralized server using a wireless network. Different users desirous of using the vehicle may have an account associated with a carried mobile device. Each user may thus access the vehicle and make vehicle-related payments via his or her own mobile device upon cessation of vehicle use. Charges made during use of the vehicle may be charged to a vehicle payment account, associated with the detachable mobile device disposed in the vehicle.

### FIELD OF THE INVENTION

The invention relates generally to contactless payments, and more specifically, to an on-vehicle payment system for multiple drivers of the same vehicle.

### BACKGROUND OF THE INVENTION

Car-sharing companies are well known. They are used in congested urban areas for those who don't need a vehicle every day. Shared-use vehicle memberships range from neighborhood Car-sharing business-models to classic Station Cars business-models, with multi-nodal shared-use vehicle business-models finding a fit somewhere in the mix.

The advantages of shared-use vehicle memberships include lower costs to drivers, lower pressure on municipalities or institutions and also businesses to increase number of parking spaces for drivers, as well as inducing drivers to forsake personally-driven vehicles in favor of mass transit. Similarly, sometimes groups of people, family members, and co-workers may share a vehicle. As such, different drivers with different needs and circumstances may drive a single vehicle at different times.

Hardware beacon-like devices installed by retailers are commonly used to communicate with a shopper's mobile phone or tablet to expedite and improve the shopping experience. Using BLE technology (Bluetooth low energy), a mobile physical device can connect to an end buyer via an electronic, low frequency rate chip. With multiple beacon devices forming a networked group, nearby smart devices can be linked together in order to allow the sending of promotional campaign ads, sales coupons, and alerts. The system may even carry out product sales in real-time. To some e-commerce and m-commerce users, this is a new experience.

However, the user experience has not been expanded to vehicle users. Oftentimes, a vehicle may have many drivers or users. As such, an owner of the vehicle may wish to establish certain parameters for use of the vehicle. To enforce stipulated uses of the vehicle, the owner may inform the other users of these parameters. For example, a car may belong to one individual while other relatives are the drivers. While on the road, the drivers may make certain purchases of goods and services. Such goods and services may be paid for by cash or credit cards. However, of the available payment options used today, none offer convenience and ease of use. A major disadvantage of this point-of-sale method is that cash requires exact change. Likewise, credit cards may present security or fraud problems. Until now, electronic or virtual money has been able to be used via smartcards with prepaid tokens stored virtually in the smartcards. The smartcards have been widely adopted in the general consumer market and may provide an additional alternative to the above modes of payments. There is typically a limit of the amount of tokens that can be stored in a given smartcard. Disadvantageously, a smartcard holder is required to pay close attention to the remaining balance, and any insufficient balance to pay for an item may render the transaction cancelled. More popular means of payment have employed NFC-type (“near-field communication”) technologies embedded in mobile phones and other transcoders. NFC is believed to be increasingly more popular for users or drivers incurring costs, especially when drivers are using multiple vehicles at different times. There are many ways that NFC tags may be read by a given merchant for purposes of payment. However, none of these methods have been perfected.

As such, there exists a need for a contactless payment system and method multiple drivers of a given vehicle.

### SUMMARY OF THE INVENTION

According to embodiments of the invention, systems and methods are provided for a shared vehicle payment system for managing various charges made on behalf of multiple drivers of a given vehicle. The disclosed systems and methods may be carried out by assigning a console and account module to a given vehicle. The console may have an associated detachable mobile device and sensor device. The vehicle may communicate with a centralized server using a wireless network. Different users desirous of using the vehicle may have an account associated with a carried mobile device. Each user may thus access the vehicle and make vehicle-related payments via his or her own mobile device upon cessation of vehicle use. Charges made during use of the vehicle may be charged to a vehicle payment account, associated with the detachable mobile device disposed in the vehicle.

In an embodiment of the disclosed technology, a shared vehicle payment system is provided for multiple users of a single vehicle. The system may have one or more of the following components, not necessarily in the following order: a) a first mobile device associated with a first user; b) a second mobile device associated with a second user; c) a vehicle console module having a detachable mobile device, the vehicle console module being disposed in the vehicle; d) a sensor device disposed in the vehicle console module; e) a centralized server; and/or f) an account module configured in the centralized server to handle account and payment management. The account module have a first user account associated with the first user, a second user account associated with the second user, and a vehicle account associated with the vehicle.

In a further embodiment, the first user may create a reservation of the vehicle by registration at a reserved time using the first mobile device. The reservation may be made via the centralized server using the first user account. Once a reservation is confirmed, the first user may check into the vehicle at the reserved time as the first user approaches the vehicle. The first user mobile device may be configured to wirelessly contact the sensor device of the vehicle to obtain vehicle identity information, and communicate the vehicle identity information and the first user account to the centralized server to confirm the reservation. The vehicle console module, upon confirmation from the centralized server, may complete the check in process by granting the first user control of the vehicle mobile module via the first mobile device.

In a further embodiment, the second user creates a reservation of the vehicle by registration at a reserved time after the first user using the second mobile device. Likewise, the reservation may be made via the centralized server using the second user account. The second user may check into the vehicle at the reserved time as the second user approaches the vehicle. The second user mobile device may be configured to wirelessly contact the sensor device of the vehicle to obtain vehicle identity information, and communicate the vehicle identity information and the second user account to the centralized server to confirm the reservation. The vehicle console module, upon confirmation from the centralized server, may complete the check in process by granting the second user control of the vehicle mobile module via the second mobile device.

The detachable mobile device may be usable to make a payment at a merchant via wireless communication on behalf of the second user. The merchant may complete the purchase using payment information associated with the vehicle account. The second user account may be billed for expenses incurred by the second user during the reservation, including any expense charged to the vehicle account. The sensor device may be a wireless beacon. Further, the vehicle identity information may be contained in a QR code.

In another embodiment of the disclosed technology, a method is provided for managing payments made by multiple users of a single vehicle. The method may be carried out, not necessarily in the following order, by: a) providing a plurality of accounts to prospective drivers of the vehicle; b) associating payment information for each driver with the account of each driver, wherein the accounts and payment information are stored on a centralized server; c) receiving, via an account module disposed in the vehicle, account information for a first user trying to access the vehicle; d) granting the first user access to the vehicle based on confirmed credentials of the account of the first user via the centralized server; e) receiving a payment request from a detachable mobile device of the vehicle for a payment to be made on behalf of the first user; f) fulfilling the payment request on behalf of the first user; and/or g) billing the first user, at a later time, for all charged accrued during access of the vehicle by the first user.

The method may employ additional steps relative to a second user, the additional steps proceed, not necessarily in the following order, by: h) receiving, via the account module disposed in the vehicle, account information for a second user trying to access the vehicle; i) granting the second user access to the vehicle based on confirmed credentials of the account of the second user via the centralized server; j) receiving a second payment request from the detachable mobile device of the vehicle for a payment to be made on behalf of the second user; k) fulfilling the payment request on behalf of the second user; and/or I) billing the second user, at a later time, for all charged accrued during access of the vehicle by the second user.

The wireless communication between the vehicle and the centralized server may be carried out via the mobile network connections of the users' mobile devices. Alternatively, the vehicle may have its own network adapter for network communication. Communication may be carried out via Wi-Fi, packet switch data networks, HSPA+, 3G, 4G and/or any other networks known in the art. Wireless communication between the user mobile devices and vehicle may be carried out via Wi-Fi, Bluetooth, NFC, barcode recognition, and/or any other close range communication methods known in the art.

A better understanding of the disclosed technology will be obtained from the following brief description of drawings illustrating exemplary embodiments of the disclosed technology.

### BRIEF DESCRIPTION OF THE DRAWINGS

FIG. 1 shows a schematic visualization of an exemplary system configuration according to embodiments of the disclosed technology.

FIG. 2 shows an overview of an exemplary arrangement of the vehicle-based payment system according to embodiments of the disclosed technology.

FIG. 3 shows a chart outlining the relationship of various components of the disclosed technology with respect to one another for purposes of making a merchant-based purchase.

FIG. 4 shows a high-level block diagram of a microprocessor device that may be used to carry out the disclosed technology.

FIG. 5 shows a visualization of a vehicle console module on a vehicle according to embodiments of the disclose technology.

FIG. 6 shows a high-level visual overview of the various physical components of the disclosed technology.

FIG. 7 shows a high-level visual overview of the spatial relationship between various system components according to embodiments of the disclosed technology.

A better understanding of the disclosed technology will be obtained from the following detailed description of embodiments of the disclosed technology, taken in conjunction with the drawings.

### DETAILED DESCRIPTION

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

According to embodiments of the invention, systems and methods are provided for a shared vehicle payment system for managing various charges made on behalf of multiple drivers of a given vehicle. The disclosed systems and methods may be carried out by assigning a console and account module to a given vehicle. The console may have an associated detachable mobile device and sensor device. The vehicle may communicate with a centralized server using a wireless network. Different users desirous of using the vehicle may have an account associated with a carried mobile device. Each user may thus access the vehicle and make vehicle-related payments via his or her own mobile device upon cessation of vehicle use. Charges made during use of the vehicle may be charged to a vehicle payment account, associated with the detachable mobile device disposed in the vehicle.

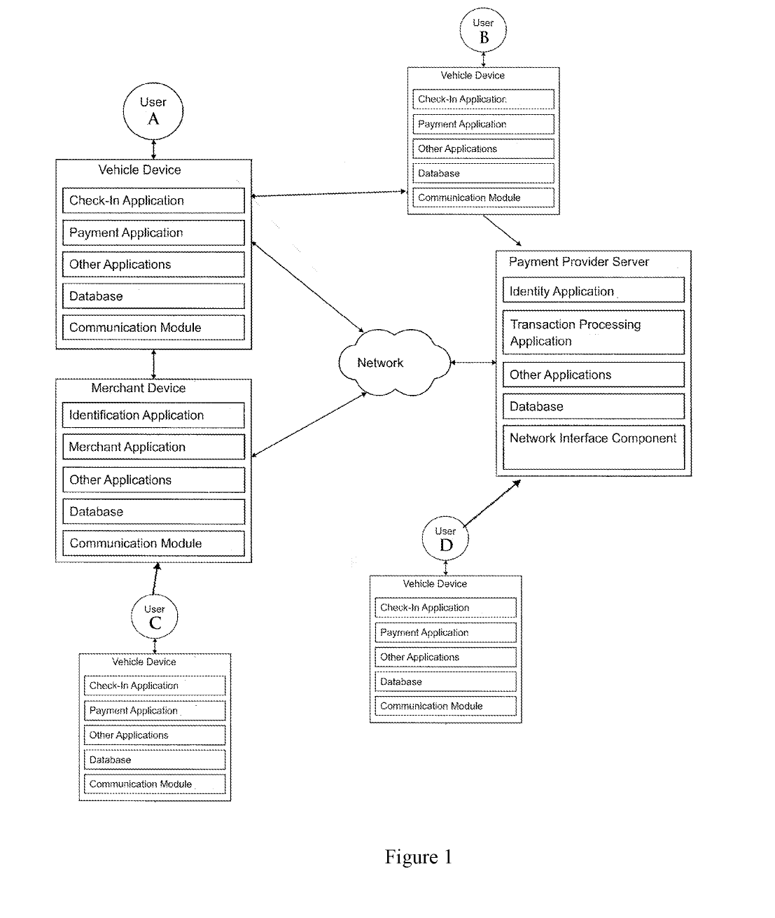

Referring now to the figures, FIG. 1 shows a schematic visualization of an exemplary system configuration according to embodiments of the disclosed technology. The example shown is relative to four hypothetical users, User A, User B, User C, and User D (hereinafter collectively referred to as “Users” or “the Users”). Each User has an associated vehicle device. The vehicle device components include a check-in application, payment application, database, communication module and other applications.

The vehicle devices are all connected to a network via a network adapter. Common users or family members may have their accounts associated with one another. Such is the case in the example shown in FIG. 1 between User A and User B. Users wishing to buy goods or services will be connected to a merchant device for purposes of carrying out a transaction. The merchant device likewise has a check-in application, payment application, database, communication module and other applications.

In order to carry out transactions, a third-party payment provider server may also be accessible via the network. The payment provider facilitates the exchange of funds electronically. The payment provider may use credit/debit cards, gift cards, outstanding balances, electronic currency (e.g. Bitcoin), ACH institutions and/or online currency exchange (e.g. PayPal). The payment provider server's components may include an identity application, a transaction processing application, a database, a network interface component, and other applications.

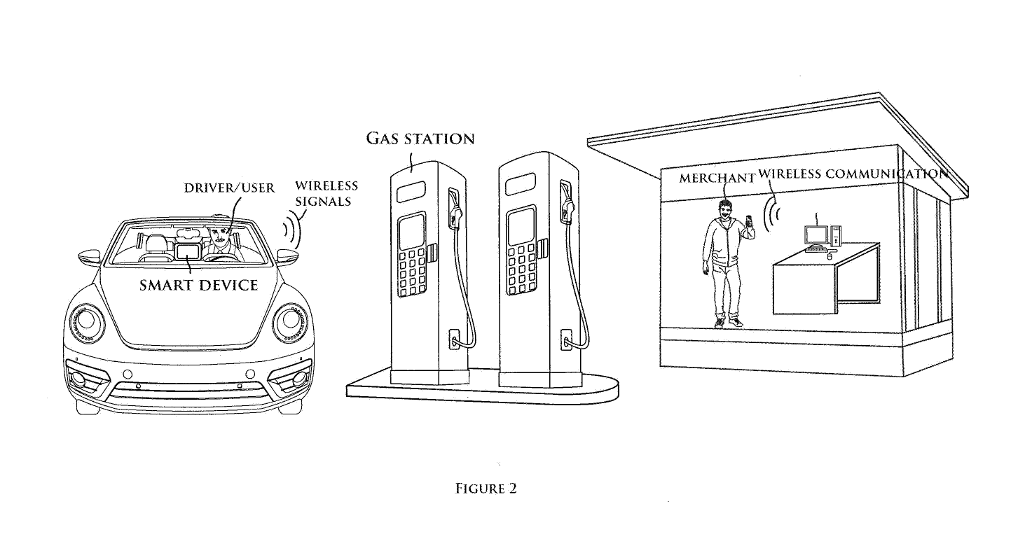

FIG. 2 shows an overview of an exemplary arrangement of the vehicle-based payment system according to embodiments of the disclosed technology. Under the disclosed technology, a vehicle driven by a user may approach, for example, a gas/petrol station to buy fuel. The fuel may be paid for using the smart device or detachable mobile device associated with the vehicle. While the user of the vehicle may change, in concept, the detachable mobile device is always tied to the vehicle. The smart device may communicate with a wireless reader located on the premises of the merchant. As such, payment information and other transaction information is passed from the mobile device to the merchant.

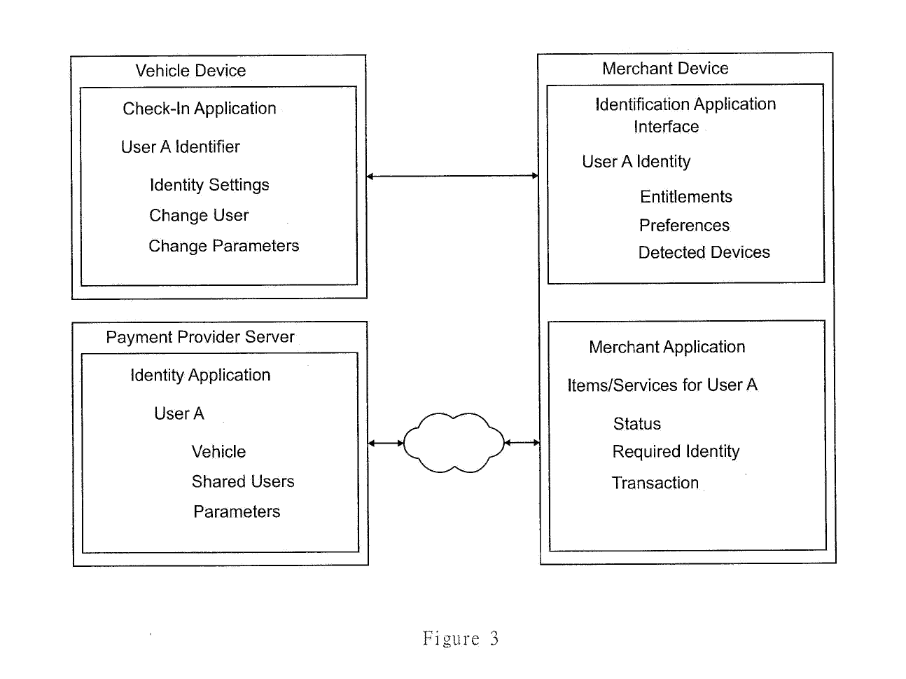

FIG. 3 shows a chart outlining the relationship of various components of the disclosed technology with respect to one another for purposes of making a merchant-based purchase. The vehicle device is shown, having an associated check-in application which operates to identify a user, in this case, User A. The vehicle device may also, amongst other tasks, identify settings, change users and change other parameters. The vehicle device directly communicates with the merchant device in order to make a transaction. The merchant device likewise has an identification application for identifying the user. As such, certain information about the user is accessed, including: entitlements, preferences and detected devices. The merchant device may also possess a merchant application which is responsible for maintaining transaction information, such as order status and items/services bought.

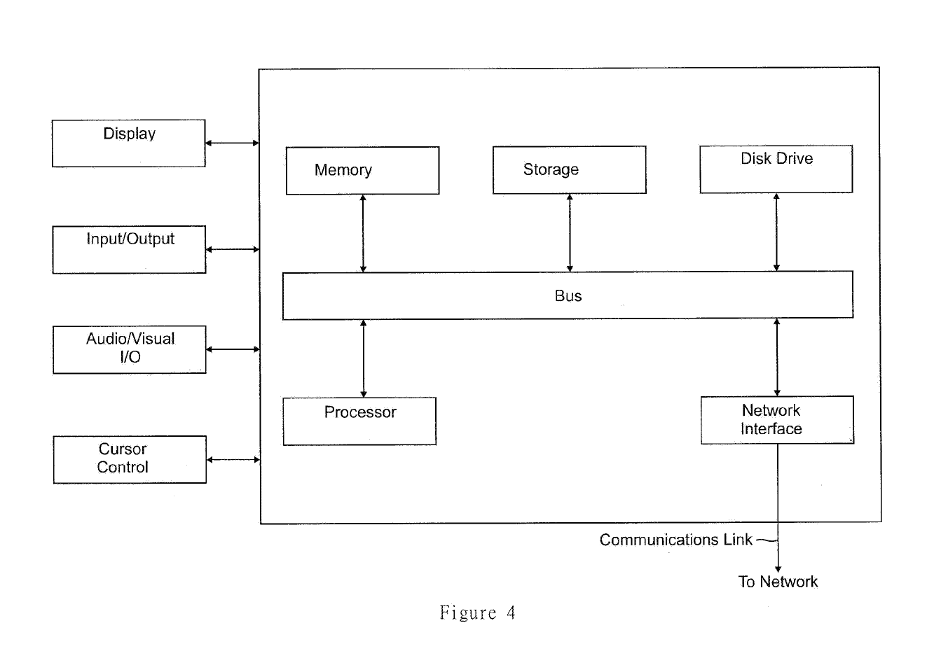

FIG. 4 shows a high-level block diagram of a microprocessor device that may be used to carry out the disclosed technology. The device comprises a processor that controls the overall operation of a computer by executing the reader's program instructions which define such operation. The reader's program instructions may be stored in a storage device (e.g., magnetic disk, database) and loaded into memory when execution of the console's program instructions is desired. Thus, the device will be defined by the program instructions stored in memory and/or storage, and the console will be controlled by processor executing the console's program instructions.

The device may also include one or a plurality of input network interfaces for communicating with a network via a communications link (e.g., the internet). The device further includes an electrical input interface for receiving power and data. The device 500 also includes one or more output network interfaces for communicating with other devices. The device may also include input/output representing devices which allow for user interaction with a computer (e.g., display, keyboard, mouse, speakers, buttons, etc.). The device may also use a display and audio visual input/output for further exchange of data and commands.

One skilled in the art will recognize that an implementation of an actual device will contain other components as well, and that FIG. 4 is a high level representation of some of the components of such a device for illustrative purposes. It should also be understood by one skilled in the art that the method and devices depicted in FIGS. 1 through 3 may be implemented on a device such as is shown in FIG. 4.

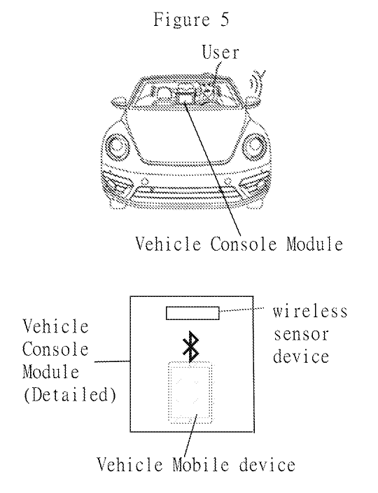

FIG. 5 shows a visualization of a vehicle console module on a vehicle according to embodiments of the disclose technology. The vehicle may have a vehicle console module having a detachable mobile device. The vehicle console module is disposed in or on the vehicle. A sensor device may be disposed in the vehicle console module. An account module associated with the vehicle may be configured in the centralized server to handle account and payment management. The account module may have a first user account associated with the first user, a second user account associated with the second user, and a vehicle account associated with the vehicle.

Referring still to FIG. 5, the detachable mobile device may be usable to make a payment at a merchant via wireless communication. The merchant may complete the purchase using payment information associated with the vehicle account. The first user may finish the reservation by notifying the centralized server via the first mobile device. The first user account may be billed for expenses incurred by the first user during the reservation, including any expense charged to the vehicle account.

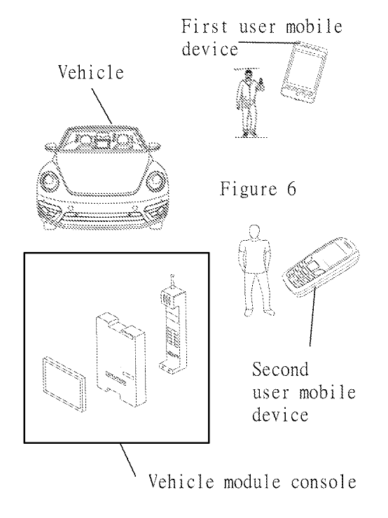

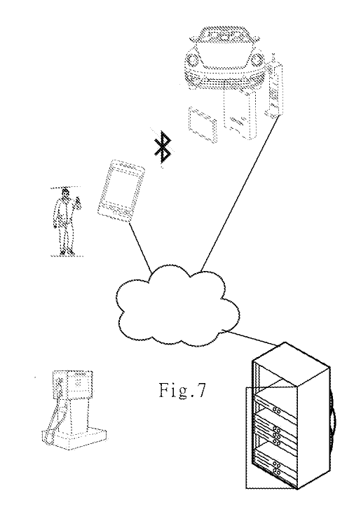

FIG. 6 shows a high-level visual overview of the various physical components of the disclosed technology. FIG. 7 shows a high-level visual overview of the spatial relationship between various system components according to embodiments of the disclosed technology. The components may include: a) a first mobile device associated with a first user; b) a second mobile device associated with a second user; c) a vehicle console module having a detachable mobile device, the vehicle console module being disposed in the vehicle; d) a sensor device disposed in the vehicle console module; e) a centralized server; and/or f) an account module configured in the centralized server to handle account and payment management.

The first user may create a reservation of the vehicle by registration at a reserved time using the first mobile device. The reservation may be made via the centralized server using the first user account. Once a reservation is confirmed, the first user may check into the vehicle at the reserved time as the first user approaches the vehicle. The first user mobile device may be configured to wirelessly contact the sensor device of the vehicle to obtain vehicle identity information, and communicate the vehicle identity information and the first user account to the centralized server to confirm the reservation. The vehicle console module, upon confirmation from the centralized server, may complete the check in process by granting the first user control of the vehicle mobile module via the first mobile device.

Referring to FIG. 6, the second user creates a reservation of the vehicle by registration at a reserved time after the first user using the second mobile device. Likewise, the reservation may be made via the centralized server using the second user account. The second user may check into the vehicle at the reserved time as the second user approaches the vehicle. The second user mobile device may be configured to wirelessly contact the sensor device of the vehicle to obtain vehicle identity information, and communicate the vehicle identity information and the second user account to the centralized server to confirm the reservation. The vehicle console module, upon confirmation from the centralized server, may complete the check in process by granting the second user control of the vehicle mobile module via the second mobile device.

The detachable mobile device may be usable to make a payment at a merchant via wireless communication on behalf of the second user. The merchant may complete the purchase using payment information associated with the vehicle account. The second user account may be billed for expenses incurred by the second user during the reservation, including any expense charged to the vehicle account. The sensor device may be a wireless beacon. Further, the vehicle identity information may be contained in a QR code.

In another embodiment of the disclosed technology, a method is provided for managing payments made by multiple users of a single vehicle. The method may be carried out, not necessarily in the following order, by: a) providing a plurality of accounts to prospective drivers of the vehicle; b) associating payment information for each driver with the account of each driver, wherein the accounts and payment information are stored on a centralized server; c) receiving, via an account module disposed in the vehicle, account information for a first user trying to access the vehicle; d) granting the first user access to the vehicle based on confirmed credentials of the account of the first user via the centralized server; e) receiving a payment request from a detachable mobile device of the vehicle for a payment to be made on behalf of the first user; f) fulfilling the payment request on behalf of the first user; and/or g) billing the first user, at a later time, for all charged accrued during access of the vehicle by the first user.

The method may employ additional steps relative to a second user, the additional steps proceed, not necessarily in the following order, by: h) receiving, via the account module disposed in the vehicle, account information for a second user trying to access the vehicle; i) granting the second user access to the vehicle based on confirmed credentials of the account of the second user via the centralized server; j) receiving a second payment request from the detachable mobile device of the vehicle for a payment to be made on behalf of the second user; k) fulfilling the payment request on behalf of the second user; and/or l) billing the second user, at a later time, for all charged accrued during access of the vehicle by the second user.

The wireless communication between the vehicle and the centralized server may be carried out via the mobile network connections of the users' mobile devices. Alternatively, the vehicle may have its own network adapter for network communication. Communication may be carried out via Wi-Fi, packet switch data networks, HSPA+, 3G, 4G and/or any other networks known in the art. Wireless communication between the user mobile devices and vehicle may be carried out via Wi-Fi, Bluetooth, NFC, barcode recognition, and/or any other close range communication methods known in the art.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a micro architecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around -5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

What is claimed:

1. A shared vehicle payment system for multiple users of a single vehicle, comprising:
a first mobile device associated with a first user;
a second mobile device associated with a second user;
a vehicle console module having a detachable mobile device, the vehicle console module being disposed in the vehicle;
a sensor device disposed in the vehicle console module;
a centralized server; and
an account module configured in the centralized server to handle account and payment management, the account module having:
a first user account associated with the first user;
a second user account associated with the second user; and
a vehicle account associated with the vehicle.

2. The system of claim 1, wherein the first user creates a reservation of the vehicle by registration at a reserved time using the first mobile device, wherein the reservation is made via the centralized server using the first user account.

3. The system of claim 2, wherein the first user checks into the vehicle at the reserved time as the first user approaches the vehicle, wherein the first user mobile device is configured to wirelessly contact the sensor device of the vehicle to obtain vehicle identity information, and communicate the vehicle identity information and the first user account to the centralized server to confirm the reservation; and further wherein the vehicle console module, upon confirmation from the centralized server, finishes the check in process by granting the first user control of the vehicle mobile module via the first mobile device.

4. The system of claim 3, wherein the detachable mobile device is usable to make a payment at a merchant via wireless communication.

5. The system of claim 4, wherein the merchant completes the purchase using payment information associated with the vehicle account.

6. The system of claim 5, wherein the first user finishes the reservation by notifying the centralized server via the first mobile device.

7. The system of claim 6, wherein the first user account is billed for expenses incurred by the first user during the reservation, including any expense charged to the vehicle account.

8. The system of claim 7, wherein the second user creates a reservation of the vehicle by registration at a reserved time after the first user using the second mobile device, wherein the reservation is made via the centralized server using the second user account.

9. The system of claim 8, wherein the second user checks into the vehicle at the reserved time as the second user approaches the vehicle, wherein the second user mobile device is configured to wirelessly contact the sensor device of the vehicle to obtain vehicle identity information, and communicate the vehicle identity information and the second user account to the centralized server to confirm the reservation; and further wherein the vehicle console module, upon confirmation from the centralized server, finishes the check in process by granting the second user control of the vehicle mobile module via the second mobile device.

10. The system of claim 9, the detachable mobile device is usable to make a payment at a merchant via wireless communication on behalf of the second user.

11. The system of claim 10, wherein the merchant completes the purchase using payment information associated with the vehicle account.

12. The system of claim 11, wherein the second user account is billed for expenses incurred by the second user during the reservation, including any expense charged to the vehicle account.

13. The system of claim 12, wherein the sensor device is a wireless beacon.

14. The system of claim 12, wherein the vehicle identity information is contained in a QR code.

15. A method for managing payments made by multiple users of a single vehicle, comprising:
providing a plurality of accounts to prospective drivers of the vehicle;
associating payment information for each driver with the account of each driver, wherein the accounts and payment information are stored on a centralized server;
receiving, via an account module disposed in the vehicle, account information for a first user trying to access the vehicle;
granting the first user access to the vehicle based on confirmed credentials of the account of the first user via the centralized server;
receiving a payment request from a detachable mobile device of the vehicle for a payment to be made on behalf of the first user;
fulfilling the payment request on behalf of the first user; and
billing the first user, at a later time, for all charged accrued during access of the vehicle by the first user.

16. The method of claim 15, further comprising steps of:
receiving, via the account module disposed in the vehicle, account information for a second user trying to access the vehicle;
granting the second user access to the vehicle based on confirmed credentials of the account of the second user via the centralized server;
receiving a second payment request from the detachable mobile device of the vehicle for a payment to be made on behalf of the second user;
fulfilling the payment request on behalf of the second user; and
billing the second user, at a later time, for all charged accrued during access of the vehicle by the second user.
